(19) United States
(12) Patent Application Publication
(10) Pub. No.: US 2024/0017453 A1
(43) Pub. Date: Jan. 18, 2024

(54) ULTRA-LOW DENSITY CONDUCTIVE THERMOPLASTIC COMPOSITE MATERIAL FOR PAINTED COMPONENTS

(71) Applicant: Ford Global Technologies, LLC, Dearborn, MI (US)

(72) Inventors: Deborah Frances Mielewski, Ann Arbor, MI (US); Paul Kenneth Dellock, Northville, MI (US); Alper Kiziltas, Sarikamis (TR); LaRon Michelle Brown, Detroit, MI (US); Stuart C. Salter, White Lake, MI (US)

(73) Assignee: Ford Global Technologies, LLC, Dearborn, MI (US)

(21) Appl. No.: 17/863,835

(22) Filed: Jul. 13, 2022

(51) Int. Cl. B29C 45/00; C08L 23/12

(52) U.S. Cl. CPC B29C 45/0001; C08L 23/12; B29K 2023/12

(57) ABSTRACT

An injection moldable composite material includes a polymer matrix, glass microspheres, a conductive network of linked nanostructures, and a plurality of additives. The polymer matrix includes a polypropylene impact copolymer. The plurality of additives includes a polymer adhesive configured to adhere the conductive network of linked nanostructures to the polymer matrix.

### FIELD

The present disclosure relates to composite materials, and more particularly to low density, conductive composites.

### BACKGROUND

The statements in this section merely provide background information related to the present disclosure and may not constitute prior art.

Motor vehicles are increasingly subjected to various emissions and fuel consumption standards. These standards are typically promulgated to lower carbon dioxide emissions, thereby reducing greenhouse gas in the atmosphere. One way to meet these standards is to reduce the weight of motor vehicles. One weight-reduction strategy is the use of composite materials in various vehicle components, which have a much lower material density than their metal counterparts.

Another priority for the automotive industry is reducing paint waste and emissions from the painting process. One method of doing so is electrostatic painting. However, electrostatic painting requires the substrate be electrically conductive or have additional layers applied.

The present disclosure addresses these challenges related to the cost effective and sustainable implementation of lightweight and conductive composite materials in motor vehicles.

### SUMMARY

This section provides a general summary of the disclosure and is not a comprehensive disclosure of its full scope or all of its features.

In one form of the present disclosure, an injection moldable composite material includes a polymer matrix, glass microspheres, a conductive network of linked nanostructures, and a plurality of additives. The polymer matrix includes a polypropylene impact copolymer. The plurality of additives includes a polymer adhesive configured to adhere the conductive network of linked nanostructures to the polymer matrix.

In variations of the injection moldable composite material, which may be implemented individually or in any combination: the polypropylene impact copolymer is in an amount between 25-55 wt. %; the glass microspheres are in an amount of 6.0 wt. %; the conductive network of linked nanostructures are in an amount of 0.5 wt. %; the recycled homopolymer is in an amount between 33.0-35.0 wt. %; the polymer matrix further comprises a recycled copolymer; the recycled copolymer is in an amount between 57.0-62.0 wt. %; the plurality of additives further comprise a melt flow enhancer; the plurality of additives further comprise a nucleator; the composite material further comprises magnesium sulfate fibers; the magnesium sulfate fibers is in an amount of 4.0 wt. %; the composite material further comprises wollastonite; the wollastonite is in an amount of 8.5 wt. %; the additives further comprise an antioxidant; the injection moldable composite material does not contain talc; and the conductive network of linked nanostructures comprise carbon nanotubes.

In another form of the present disclosure, an injection moldable composite material includes a polymer matrix, glass microspheres, a conductive network of linked nanostructures, at least one of magnesium sulfate fibers and wollastonite, and a plurality of additives. The polymer matrix includes a polypropylene impact copolymer and at least one of a recycled homopolymer and a recycled copolymer. The plurality of additives includes a polymer adhesive configured to adhere the conductive network of linked nanostructures to the polymer matrix.

In some forms of this injection moldable composite material, the composite material does not contain talc.

In yet another form, an injection moldable composite material includes a polymer matrix, glass microspheres, a conductive network of linked carbon nanostructures, at least one of magnesium sulfate fibers and wollastonite, and a plurality of additives. The polymer matrix includes a polypropylene impact copolymer and at least one of a recycled homopolymer and a recycled copolymer. The plurality of additives includes a polymer adhesive configured to adhere the conductive network of linked nanostructures to the polymer matrix. The injection molded composite material does not include talc.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a composite material according to the present disclosure;

FIG. 2 is a flow diagram illustrating a method of manufacturing a component from the composite material of FIG. 1; and

FIG. 3 is a schematic view of an apparatus for the method of FIG. 2.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

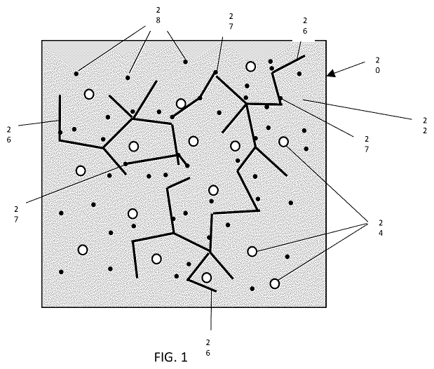

Referring to FIG. 1, an injection moldable composite material according to the teachings of the present disclosure is illustrated and generally indicated by reference numeral 20. The composite material 20 includes a polymer matrix 22, glass microspheres 24, a conductive network of linked nanostructures 26, and a plurality of additives 28.

As set forth in greater detail below with different inventive composite material formulations, the polymer matrix 22 includes a polypropylene impact copolymer. The polypropylene impact copolymer has a high ethylene content suitable for painted bumper fascia, door cladding, and rocker moldings. In some forms, the impact copolymer has a rubber content over 25%. In one form, the polypropylene impact copolymer is in an amount between 25-55 wt. %. In some forms, the polymer matrix 22 also includes a recycled homopolymer. In one form of this variation, the recycled homopolymer is in an amount between 33.0-35.0 wt. %. In one form, the recycled homopolymer may be manufactured from recycled polypropylene carpet fiber. In some forms, the polymer matrix also includes a recycled copolymer. In one form of this variation, the recycled copolymer is in an amount between 57.0-62.0 wt. %. In one form, the recycled copolymer may be derived from recycled bottle caps and seals. In some forms, virgin materials can be substituted for the recycled materials. These and other variations, along with material properties are set forth in greater detail below.

As used herein, the glass microspheres 24 are very low-density glass bubbles. The glass microspheres are a filler which provide volume to the composite 20 with a reduced weight compared to commonly used fillers such as talc. In some forms, the glass microspheres 24 have a density of less than 0.50 g/cc. In some forms, the glass microspheres 24 may be chemically strengthened glass bubbles developed to withstand pressures over 100 MPa. In one form, the glass microspheres 24 are in an amount of 6.0 wt. % of the composite material 20. Advantageously, in one form of the present disclosure, the composite material 20 contains no talc.

As used herein, the conductive network of linked nanostructures 26 refers to a crosslinked network of nanostructures connected at a plurality of nodes 27, which together form an electrically conductive pathway throughout the composite material 20. In one form, the nanostructures are carbon nanotubes. Advantageously, the nanostructure network has improved dispersion at high sheer (as described in greater detail below) compared to unlinked nanotubes. The network of linked nanostructures 26 further reduces the electrical resistivity of the composite material 20, improving the efficiency of electrostatic painting. In some forms, the surface resistivity is less than 1×10⁻⁸ ohm meter (Ω·m) and may be below 1×10⁻⁶ Ω·m. In one form, the composite material contains 0.5 wt. % of the conductive network of linked nanostructures 26. This variation may have a surface resistivity of about 1×10⁻⁶ Ω·m. Therefore, the conductive network of linked nanostructures 26 provides enough conductivity to result in a composite material that is statically dissipative, thus enabling efficient paint transfer.

The plurality of additives 28 includes a polymer adhesive configured to adhere the conductive network of linked nanostructures to the polymer matrix. In one form, the polymer adhesive may be a resin-based adhesive used as a coupling agent. The polymer adhesive improves the ductility of the composite material, enhances the impact properties, and increases the bond strength between the polymer matrix and the other elements of the composite material. In some forms, 0.0-5.0 wt. % of polymer adhesive is used. In one form, 1.0 wt. % of polymer adhesive is used. In some variations, the additives 28 also include at least one of a melt flow enhancer, a nucleator to maximize molding speed while enhancing stiffness and impact strength, 0.2-2.0 wt. % of an antioxidant which acts as a melt processing stabilizer. In addition, in some forms of the composite material 20, the additives 28 may include a flame retardant, a colorant, and a UV light stabilizer, as needed based on the intended application of the composite material.

Additionally, in some forms, the composite material 20 includes an additional structural filler which may be magnesium oxysulfate fibers or wollastonite. In certain applications, the structural filler provides improved heat deflection. In addition, compared to talc, these materials aid in increasing the tensile strength flex modulus and notched Charpy impact. In some forms, the amount of magnesium oxysulfate fibers is 4.0-5.0 wt. %. In some forms, the content of wollastonite is 8.0-10.0 wt. %. In one form, 8.5 wt. % wollastonite may be used.

As set forth above, the composite material 20 in one form does not include talc. Talc is known in the prior art as a component of composite materials for the particular applications contemplated by the present disclosure. However, talc is an insulator and has a higher density compared to teachings of the present disclosure.

Table 1 below shows four variations of the composite material 20 according to the present disclosure.

TABLE 1

| | A (wt. %) | B (wt. %) | C (wt. %) | D (wt. %) |
|---|---|---|---|---|
| Polypropylene | 52.4 | 25.2 | 49.9 | 26.0 |
| impact co-polymer | | | | |
| Recycled homopolymer | 35.0 | | 33.0 | |
| Recycled copolymer | | 62.0 | | 57.2 |
| Melt flow enhancer | 0.5 | 0.2 | 0.5 | 0.2 |
| Nucleator | 0.3 | 0.3 | 0.3 | 0.3 |
| Glass microspheres | 6.0 | 6.0 | 6.0 | 6.0 |
| Magnesium oxysulfate | 4.0 | 4.0 | | |
| fibers | | | | |
| Wollastonite | | | 8.5 | 8.5 |
| Polymer adhesive | 1.0 | 1.0 | 1.0 | 1.0 |
| Antioxidant | 0.3 | 0.3 | 0.3 | 0.3 |
| Conductive network of | 0.5 | 0.5 | 0.5 | 0.5 |
| linked nanostructures | | | | |

It should be understood that these are example formulations as the base recycled material properties (i.e., recycled homopolymer, recycled copolymer, and/or recycled fillers) may have different physical properties.

All formulations A, B, C, and D contain polypropylene impact copolymer, melt flow enhancer, a nucleator, glass microspheres, polymer adhesive, an antioxidant, and the conductive network of linked nanostructures. The formulations vary as to the type of recycled materials used in the polymer matrix, and the type of structural filler.

Formulation A uses a recycled homopolymer polypropylene carpet fibers and magnesium oxysulfate whiskers. Formulation B uses a recycled polypropylene copolymer derived from recycled bottle caps and magnesium oxysulfate whiskers. Formulation C is substantially the same as formulation A with Wollastonite substituted for magnesium oxysulfate whiskers. Formulation D is substantially the same as formulation B with Wollastonite substituted for magnesium oxysulfate whiskers.

Table 2 below shows some material properties of the formulations of Table 1.

TABLE 2

| | A | B | C | D |
|---|---|---|---|---|
| Tensile strength at yield (MPa) | 26.20 | 26.20 | 28.20 | 28.40 |
| Tensile module (GPa) | 2.30 | 2.20 | 2.40 | 2.20 |
| Notched Charpy 23° C. (Kj/M²) | 4.3 | 4.60 | 4.8 | 4.3 |
| Notched Charpy 0° C. (Kj/M²) | 3.8 | 3.9 | 4.4 | 4.1 |
| Notched Charpy −40° C. (Kj/M²) | 2.4 | 2.3 | 3.0 | 2.6 |
| Flexural Modulus (GPa) | 1.9 | 1.70 | 2 | 2.1 |
| Heat Deflection Temperature (° C.) | 65.0 | 65.0 | 71 | 71 |
| Density (g/cc) | 0.9 | 0.92 | 0.96 | 0.96 |
| Melt flow (g/10 min) | 28.5 | 28 | 25.5 | 24 |

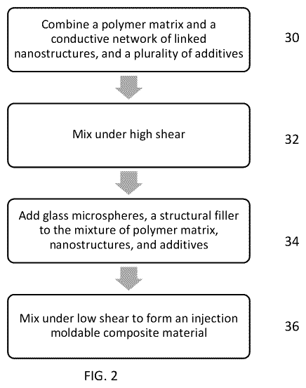

With reference to FIG. 2, a flow diagram illustrating a process for manufacturing the composite material 20 is shown. The process begins in block 30, in which a polymer matrix, a conductive network of linked nanostructures, and a plurality of additives are combined. The combination is mixed under high shear (block 32). Next, glass microspheres and a structural filler are added to the mixture as shown in block 34. All the components are then mixed under low shear in block 36, and the injection moldable composite material 20 is formed. The composite material 209 may then be formed into the desired components/parts via injection molding or die casting.

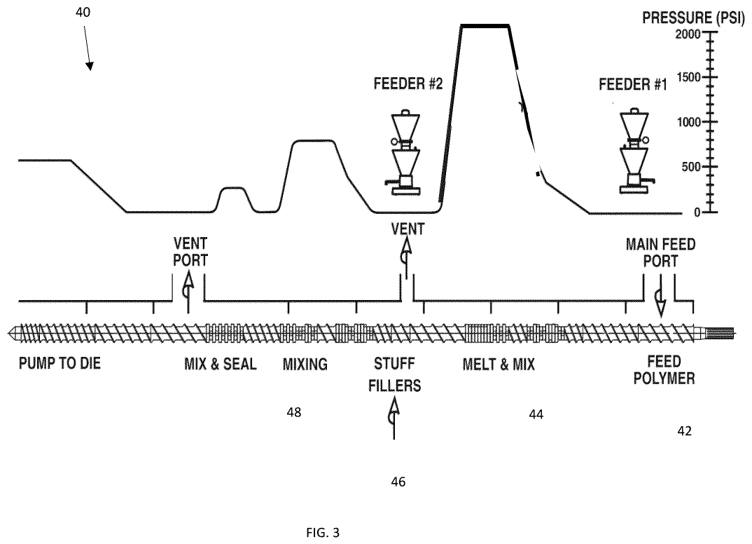

Now referring to FIG. 3, an apparatus 40 is illustrated which in some forms is used for the method discussed above. In some forms, the apparatus 40 is a high-speed twin extruder with co-rotating screws designed to have high shear and low shear sections. The high shear in general will untangle the carbon nanostructures, thus enabling further improvements in conductivity. In some forms, the extruder may have a length to diameter ratio of at least 32/1. In some forms, the length to diameter ratio may be greater than 40/1, to help provide a homogenized mixture. In this apparatus 40, the polymer matrix and the nanostructures may be added at or before a first feeder 42 and mixed at a high shear in a first mixing section 44. The glass microspheres and structural fillers may be added following the high shear portion of the extruder in a second feeder 46 and mixed at a lower shear in a second mixing section 48. From the extruder 40, the composite material 20 may be fed into an injection molding apparatus (not shown) and formed into the desired components.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An injection moldable composite material comprising:
a polymer matrix comprising a polypropylene impact copolymer;
glass microspheres;
a conductive network of linked nanostructures; and
a plurality of additives,
wherein the plurality of additives includes a polymer adhesive configured to adhere the conductive network of linked nanostructures to the polymer matrix.

2. The injection moldable composite material according to claim 1, wherein the polypropylene impact copolymer is in an amount between 25-55 wt. %.

3. The injection moldable composite material according to claim 1, wherein the glass microspheres are in an amount of 6.0 wt. %.

4. The injection moldable composite material according to claim 1, wherein the conductive network of linked nanostructures are in an amount of 0.5 wt. %.

5. The injection moldable composite material according to claim 1, wherein the polymer matrix further comprises a recycled homopolymer.

6. The injection moldable composite material according to claim 5, wherein the recycled homopolymer is in an amount between 33.0-35.0 wt. %.

7. The injection moldable composite material according to claim 1, wherein the polymer matrix further comprises a recycled copolymer.

8. The injection moldable composite material according to claim 7, wherein the recycled copolymer is in an amount between 57.0-62.0 wt. %.

9. The injection moldable composite material according to claim 1, wherein the plurality of additives further comprises a melt flow enhancer.

10. The injection moldable composite material according to claim 1, wherein the plurality of additives further comprises a nucleator.

11. The injection moldable composite material according to claim 1, further comprising magnesium oxysulfate fibers.

12. The injection moldable composite material according to claim 11, wherein the magnesium oxysulfate fibers is in an amount of 4.0 wt. %.

13. The injection moldable composite material according to claim 1, further comprising wollastonite.

14. The injection moldable composite material according to claim 13, wherein the wollastonite is in an amount of 8.5 wt. %.

15. The injection moldable composite material according to claim 1, wherein the additives further comprise an antioxidant.

16. The injection moldable composite material according to claim 1, wherein the injection moldable composite material does not contain talc.

17. The injection moldable composite material according to claim 1, wherein the conductive network of linked nanostructures comprises carbon nanotubes.

18. An injection moldable composite material comprising:
a polymer matrix comprising a polypropylene impact copolymer and at least one of a recycled homopolymer and a recycled copolymer;
glass microspheres;
a conductive network of linked nanostructures;
at least one of magnesium oxysulfate fibers and wollastonite; and
a plurality of additives,
wherein the plurality of additives includes a polymer adhesive configured to adhere the conductive network of linked nanostructures to the polymer matrix.

19. The injection moldable composite material according to claim 18, wherein the injection moldable composite material does not contain talc.

20. An injection moldable composite material comprising:
a polymer matrix comprising a polypropylene impact copolymer and at least one of a recycled homopolymer and a recycled copolymer;
glass microspheres;
a conductive network of linked carbon nanostructures;
at least one of magnesium oxysulfate fibers and wollastonite; and
a plurality of additives,
wherein the plurality of additives includes a polymer adhesive configured to adhere the conductive network of linked nanostructures to the polymer matrix, and the injection moldable composite material does not contain talc.
